(19) United States
(12) Patent Application Publication
(10) Pub. No.: US 2026/0311899 A1
(43) Pub. Date: Oct. 8, 2026

(54) LEAK CONTAINMENT AND SUPPORT HOUSING SYSTEM

(71) Applicant: NuGen, LLC, Charlotte, NC (US)

(72) Inventor: Stephen K. Rhyne, Charlotte, NC (US)

(21) Appl. No.: 19/266,327

(22) Filed: Jul. 11, 2025

Related U.S. Application Data
(60) Provisional application No. 63/671,379, filed on Jul. 15, 2024.
(60) Provisional application No. 63/769,914, filed on Mar. 11, 2025.

(51) Int. Cl. G21C 13/10; F16J 15/00

(52) U.S. Cl. CPC G21C 13/10; F16J 15/004

(57) ABSTRACT

Various embodiments of the present disclosure provide a secondary leak containment and support housing for a containment vessel, the secondary leak containment and support housing employing a housing containing a fluid and defining a through hole or an aperture which is sealed about a rotating shaft. In an example embodiment, a leak containment system includes a containment vessel structured to define a first drive shaft seal aperture, a secondary leak containment and support housing secured to the containment vessel, wherein the secondary leak containment and support housing is structured to define a second drive shaft seal aperture, a drive shaft extending through the first drive shaft seal aperture of the containment vessel and through the second drive shaft seal aperture of the secondary leak containment and support housing, wherein the drive shaft is configured to rotate relative to the containment vessel and the secondary leak containment and support housing, a primary seal disposed at least partially within the first drive shaft seal aperture that is structured to provide gas-tight sealing between the drive shaft and the containment vessel, and a secondary seal disposed at least partially within the second drive shaft seal aperture that is structured to provide gas-tight sealing between the drive shaft and the secondary leak containment and support housing. The housing also may form part of the containment vessel or be incorporated in a housing assembly that is embedded, wholly or partially, in the containment vessel.

### CROSS-REFERENCE TO RELATED APPLICATIONS

This application claims the benefit of U.S. Provisional Application No. 63/769,914, filed Mar. 11, 2025, and U.S. Provisional Application No. 63/671,379, filed Jul. 15, 2024, the contents of each of which is incorporated by reference herein in its entirety.

### FIELD OF THE INVENTION

Example embodiments of the present disclosure generally relate to a secondary leak containment and support housing for a containment vessel and, more particularly, to a secondary leak containment and support housing employing a sealed housing which surrounds a portion of the drive shaft extending from a containment vessel, providing supplemental support for the drive shaft and leak prevention from the containment vessel by way of the housing which comprises a secondary set of shaft seals to contain a gas in the housing.

### BACKGROUND

Containment vessels or containment structures are used in a variety of industries and applications. Applicant has identified a number of deficiencies and problems associated with existing containment vessels, including but not limited to, pressurized and unpressurized containment vessels in a nuclear power generation apparatus. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include apparatuses, methods, and systems for nuclear power generation, particularly, a direct-cycle nuclear power generation apparatus having a containment vessel and using a gas as the working fluid. Embodiments of the present disclosure include a secondary leak containment and support housing for a containment vessel, the secondary leak containment and support housing employing a housing containing a fluid and defining a through hole or aperture which is sealed about a rotating shaft. The secondary leak containment and support housing may be mounted to a containment vessel at a location where the shaft extends through the wall of the containment vessel. Additionally or alternatively, in some embodiments, the secondary leak containment and support housing also may form part of the containment vessel or otherwise itself be embedded, wholly or partially, in the containment vessel. In some embodiments, a primary seal is disposed between the shaft and the containment vessel wall, or, in the case of a secondary leak containment and support housing that is embedded wholly or partially in the containment vessel, between the shaft and where it enters the secondary leak containment and support housing. The shaft may be sealed by the secondary leak containment and support housing at a secondary seal, which creates a chamber that prevents leaks to the surrounding area should the primary seal fail.

According to some embodiments described herein, a leak containment system is provided, the leak containment system including a containment vessel structured to define a first drive shaft seal aperture, a secondary leak containment and support housing secured to the containment vessel, wherein the secondary leak containment and support housing is structured to define a second drive shaft seal aperture, a drive shaft extending through the first drive shaft seal aperture of the containment vessel and through the second drive shaft seal aperture of the secondary leak containment and support housing, wherein the drive shaft is configured to rotate relative to the containment vessel and the secondary leak containment and support housing, a primary seal disposed at least partially within the first drive shaft seal aperture that is structured to provide gas-tight sealing between the drive shaft and the containment vessel; and a secondary seal disposed at least partially within the second drive shaft seal aperture that is structured to provide gas-tight sealing between the drive shaft and the secondary leak containment and support housing.

In some embodiments, the secondary leak containment and support housing further comprises a gas, the gas within the secondary leak containment and support housing held at a first pressure higher than a fluid within the containment vessel. In some embodiments, the first pressure of the gas is greater than an atmospheric pressure surrounding the containment vessel.

In some embodiments, the leak containment system further includes one or more pressure sensors configured to detect a pressure of the gas within the secondary leak containment and support housing. In certain embodiments, the one or more pressure sensors include a pressure gauge configured to measure the pressure of the gas within the secondary leak containment and support housing. The leak containment system of some embodiments further includes a valve disposed in the secondary leak containment and support housing, wherein the valve is configured to enable the gas within the secondary leak containment and support housing to be pressurized. In still other embodiments, the leak containment system further includes a valve disposed in the secondary leak containment and support housing, wherein the valve is configured to allow fluids to be added or released from the secondary leak containment and support housing.

In some embodiments, the leak containment system further includes one or more sensors configured to monitor radiation in the secondary leak containment and support housing.

In some embodiments, the leak containment system further includes one or more sensors configured to determine gas composition in the secondary leak containment and support housing.

In some embodiments, the leak containment system further includes one or more sensors configured to detect moisture levels in the secondary leak containment and support housing.

In some embodiments, the leak containment system further includes one or more sensors configured to detect temperature in the secondary leak containment and support housing.

In some embodiments, one or more bearings are disposed in association with the secondary seal.

In some embodiments, the gas within the secondary leak containment and support housing is inert or a low-reactivity gas. In some embodiments, the gas is a noble gas. In still other embodiments, the gas within the secondary leak containment and support housing is non-inert or a non-low reactivity gas.

In some embodiments, the containment vessel houses a reactor core with fissile material for a nuclear power generation apparatus.

According to another exemplary embodiment described herein, a leak containment system is provided, the leak containment system including a containment vessel structured to define a first drive shaft seal aperture, a secondary leak containment and support housing wholly or partially embedded in the containment vessel, wherein the secondary leak containment and support housing comprises a distal wall and a containment vessel engagement wall, wherein the distal wall is structured to define a second drive shaft seal aperture and the containment vessel engagement wall is structured to define a third drive shaft seal aperture, and wherein the first drive shaft seal aperture of the containment vessel and the third drive shaft seal aperture of the secondary leak containment and support housing are concentrically aligned, a drive shaft extending through the first drive shaft seal aperture of the containment vessel and the second drive shaft seal aperture and the third drive shaft seal aperture of the secondary leak containment and support housing, wherein the drive shaft is configured to rotate relative to the containment vessel and the secondary leak containment and support housing, a primary seal disposed at least partially within the third drive shaft seal aperture that is structured to provide gas-tight sealing between the drive shaft and the secondary leak containment and support housing proximate the containment vessel; and a secondary seal disposed at least partially within the second drive shaft seal aperture that is structured to provide gas-tight sealing between the drive shaft and the secondary leak containment and support housing at the wall of the secondary leak containment and support housing opposite the containment vessel.

In some embodiments, the secondary leak containment and support housing and the containment vessel are of compatible materials or of the same material.

In some embodiments, the secondary leak containment and support housing is formed of a nuclear-qualified material.

In some embodiments, the secondary leak containment and support housing further comprises a gas, the gas within the secondary leak containment and support housing being held at a first pressure higher than a second pressure of a fluid within the containment vessel. In some further embodiments, the first pressure is greater than an atmospheric pressure surrounding the containment vessel. In still some further embodiments, the leak containment system further comprises one or more pressure sensors configured to detect a pressure of the gas within the secondary leak containment and support housing. In some embodiments, the leak containment system further comprises a valve disposed in the secondary leak containment and support housing, wherein the valve is configured to enable the gas within the secondary leak containment and support housing to be pressurized. In still other embodiments, the leak containment system further comprises a valve disposed in the secondary leak containment and support housing, wherein the valve is configured to allow fluids to be added or released from the secondary leak containment and support housing.

In some embodiments, the gas within the secondary leak containment and support housing is inert or low-reactivity gas.

In some embodiments, wherein an extended portion of the containment vessel engagement wall is structured to extend within the containment vessel, the extended portion defines an outer surface that is sized to engage and seal an inner surface of the first drive shaft seal aperture, and the extended portion further defines an inner surface defining the third drive shaft seal aperture.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described the present disclosure in general terms, reference will now be made to the accompanying drawings, which are not necessarily drawn to scale. The components illustrated in the figures may or may not be present in certain embodiments described herein. Some embodiments may include fewer (or more) components than those shown in the figures.

FIGS. 1A and 1B illustrate section views of example implementations of the secondary leak containment and support housing in a leak containment system according to an example embodiment of the present disclosure.

FIG. 2 depicts a perspective view of a leak containment system according to an example embodiment of the present disclosure.

FIG. 3 depicts a section view of the leak containment system of FIG. 2 according to an example embodiment of the present disclosure.

FIG. 4A depicts an example architecture of the area around where a shaft extends through a containment vessel facilitating the mounting of a secondary leak containment and support housing according to an example embodiment of the present disclosure.

FIG. 4B depicts a cross-sectional view of the example embodiment depicted in FIG. 4A of the present disclosure.

FIG. 4C depicts another cross-sectional view of the example embodiment depicted in FIG. 4A of the present disclosure.

FIG. 5A depicts a perspective view of an example secondary leak containment and support housing partially embedded in a containment vessel according to an example embodiment of the present disclosure.

FIG. 5B depicts a cross-sectional view of the example embodiment depicted in FIG. 5A of the present disclosure.

FIG. 5C depicts another cross-sectional view of the example embodiment of FIG. 5A of the present disclosure.

### DETAILED DESCRIPTION

The present disclosure more fully describes various embodiments hereinafter with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements.

The terminology used herein is for the purpose of describing particular embodiments only and is not intended to be limiting of the disclosure. In describing the embodiments, it will be understood that several techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Moreover, while certain embodiments of the present disclosure are described herein with reference to a containment vessel of a nuclear power generation apparatus, it should be appreciated and one of ordinary skill in the art will recognize that the disclosed concepts may be used in any of a myriad of contexts. For example, the leak containment system and secondary leak containment and support housing of the present application may be used in conjunction with a pressurized vessel for a supercritical carbon dioxide power system.

### Overview

Among a variety of other uses, containment vessels may be used in a nuclear power generation apparatus, in which, for example, the containment vessel may contain a gas used as the reactor coolant or as the propellant for energy conversion. That is, a containment vessel houses, holds, or otherwise contains a working fluid or operating gas (e.g., used as the reactor coolant, and in some cases, a gas propellant for the energy conversion, of the nuclear power generation apparatus). When so used, the pressure and purity of the gas in the containment vessel needs to be maintained, and the release of the gas, and any radioactive materials, needs to be prevented. Such containment vessels that are pressurized relative to their environment may be more prone to leaking through joints, seams, couplings, and seals. In addition, certain gases, such as helium, an inert gas, are considered to be particularly “leaky” due to their small molecular volume.

This issue may be exacerbated when dealing with components that pass through a wall of a containment vessel, such as a drive shaft requiring freedom to rotate while also passing from an inner surface of a containment vessel to an outer surface thereof. A rotating shaft cannot be fixedly coupled to a surface through which it passes as the shaft requires the freedom to rotate. Further, this rotation can produce undesirable friction and wear with materials that contact the shaft as it rotates. Thus, it is challenging to properly seal a vessel with a rotating shaft passing through a wall of the vessel.

To surmount these problems and others, the inventor has determined that a secondary leak containment and support housing would be desirable and advantageous by providing a unique technique of employing a sealed housing which surrounds a portion of the drive shaft extending from a containment vessel, providing supplemental support for the drive shaft and leak prevention from the containment vessel by way of the housing which comprises a secondary set of shaft seals to contain a gas in the housing.

### Example Terminology

As used herein, “payload” refers to the functional attachment(s) or component(s) at the distal end of a drive shaft, such as, but not limited to, a flywheel, a generator, a propeller, or any component that may use the rotational power of a driven shaft.

As used herein, the term “fluid” should be understood to encompass not only liquids, but also gases. Therefore, wherever the term “fluid” is used, it should be interpreted to include “gas” unless otherwise specified or clear from the context.

The term “comprising” means including but not limited to and should be interpreted in the manner it is typically used in the patent context. Use of broader terms such as comprises, includes, and having should be understood to provide support for narrower terms such as “consisting of,” “consisting essentially of,” and “comprised substantially of”.

The phrases “in one embodiment,” “according to one embodiment,” “in some embodiments,” and the like generally mean that the particular feature, structure, or characteristic following the phrase may be included in the at least one embodiment of the present disclosure and may be included in more than one embodiment of the present disclosure. Thus, the particular feature, structure, or characteristic may be included in more than one embodiment of the present disclosure such that these phrases do not necessarily refer to the same embodiment. Further, “based on,” “based at least in part on,” “based at least on,” “based upon,” and/or similar words are used herein interchangeably in an open-ended manner such that they do not indicate being based only on or based solely on the referenced element or elements unless so indicated.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such a component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “set” refers to a collection of one or more items.

The term “plurality” refers to two or more items.

The term “or” is used herein in both the alternative and conjunctive sense, unless otherwise indicated.

### Example Apparatus and System

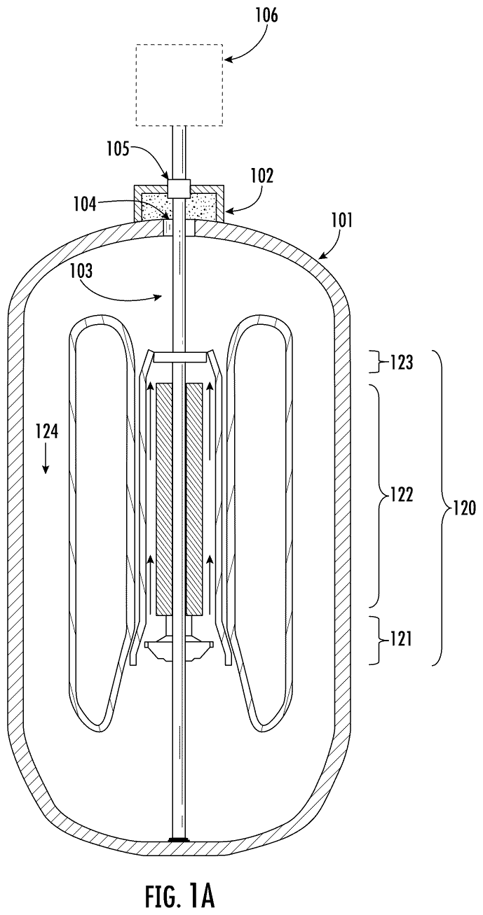

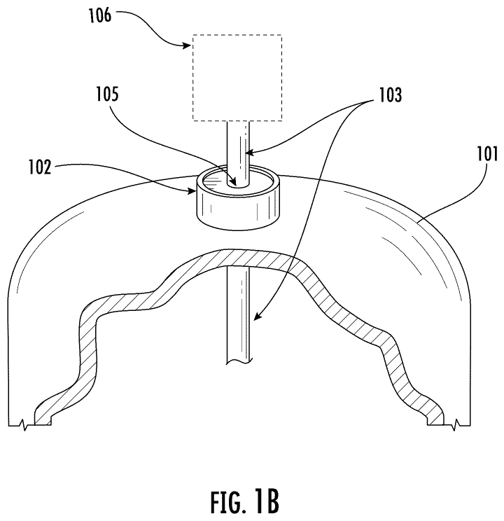

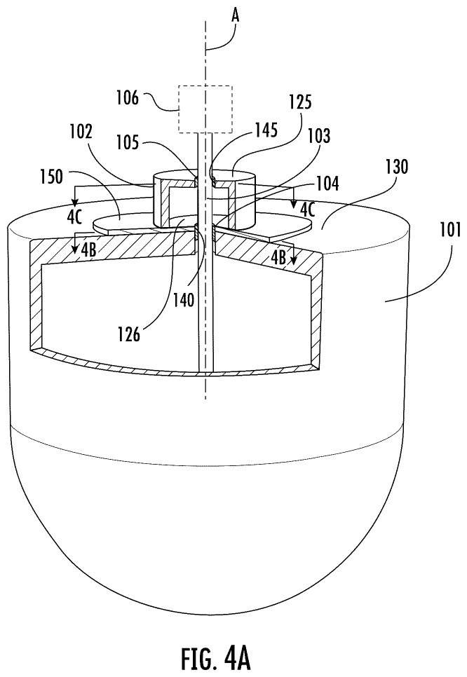

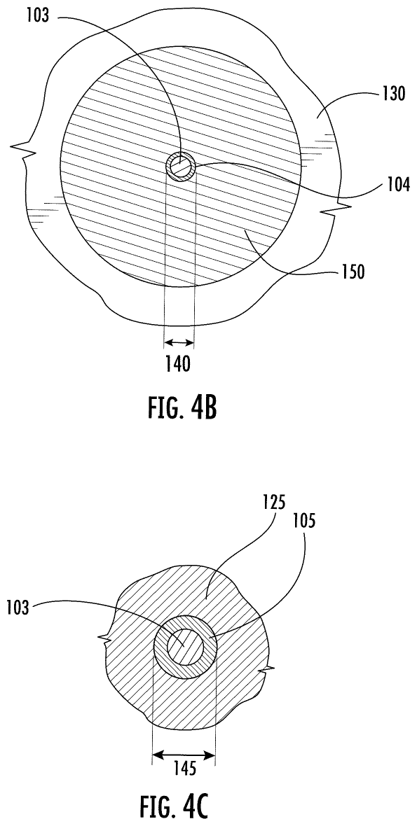

With reference to FIGS. 1A and 1B, a secondary leak containment and support housing 102 in a leak containment system according to one example embodiment is illustrated. As shown, a segment of a containment vessel 101 has a shaft 103 (e.g., a drive shaft) protruding from a cavity of the containment vessel 101 to an exterior portion of the containment vessel 101. For example, in some embodiments, the containment vessel 101 is structured to define a first drive shaft seal aperture 140 through which the shaft 103 extends externally of the containment vessel 101. As further depicted in FIGS. 4A and 4B, a secondary leak containment and support housing engagement wall 130 and/or reinforcement plate 150 (as described in greater detail herein) of the containment vessel 101 defines the first drive shaft seal aperture 140. A primary seal 104 is located at this first drive shaft seal aperture 140 or protrusion to prevent fluid from passing through any gaps caused by this first drive shaft seal aperture 140 or protrusion. The primary seal 104 is disposed at least partially within the first drive shaft seal aperture 140 such that it is structured to provide gas-tight sealing (e.g., a first gas-tight seal) between the shaft 103 and containment vessel 101. For example, in some embodiments, the primary seal 104 surrounds the shaft 103 as the shaft 103 exits the containment vessel 101. In some embodiments, although not depicted in the figures, the configuration of the primary seal 104 depends on the configuration of the shaft 103 and the structural supports, seals, and bearings otherwise associated with the shaft 103, among other factors.

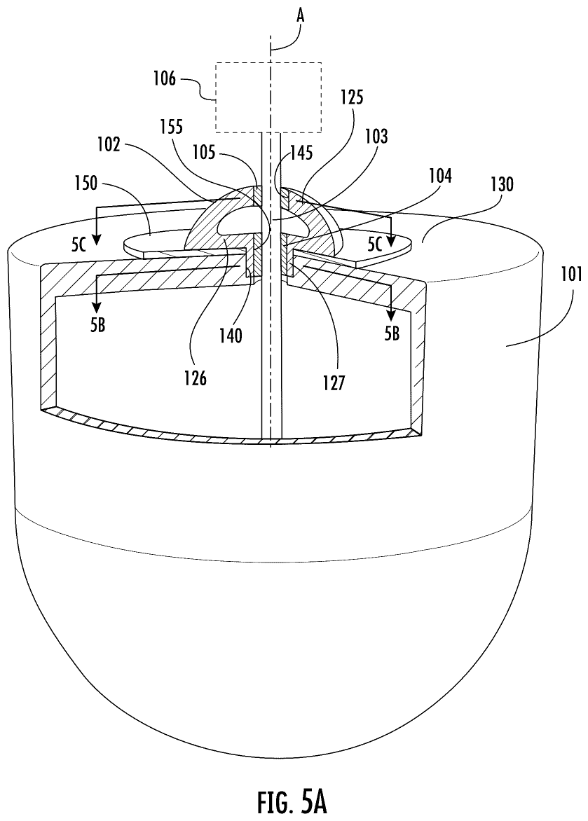

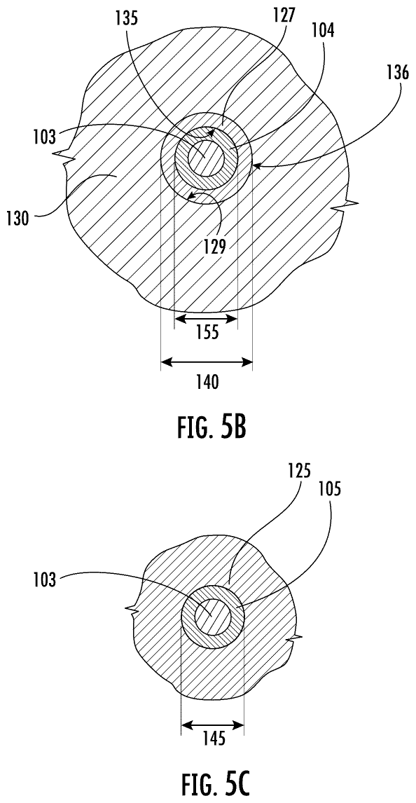

A secondary leak containment and support housing 102 is mounted to (or formed as part of) the outer surface of the containment vessel 101 proximate this first drive shaft seal aperture 140 or protrusion. As depicted in FIGS. 1A and 1B, in some embodiments, a portion of the shaft 103 passes through another aperture (e.g., the second drive shaft seal aperture 145) defined at a distal surface (or distal wall 125 as depicted in FIGS. 4A and 5A) of the secondary leak containment and support housing 102. That is, in some embodiments, the secondary leak containment and support housing 102 is structured to define a second drive shaft seal aperture 145 (at a distal surface of the housing 102 opposite of the containment vessel 101) through which the shaft 103 extends. A secondary seal 105 is disposed at least partially within the second drive shaft seal aperture 145 and is structured to provide gas-tight sealing between the shaft 103 and the secondary leak containment and support housing 102 (i.e., where the shaft 103 passes through such second drive shaft seal aperture 145 of the secondary leak containment and support housing 102 as depicted in FIG. 4C).

In some embodiments, the shaft 103 (e.g., drive shaft) is configured to rotate relative to the containment vessel 101 and the secondary leak containment and support housing 102. For example, in some embodiments, a payload 106 is attached or otherwise connected to the distal end of the shaft 103 that is exterior of the containment vessel 101 (e.g., exterior of the leak containment system). For example, the payload 106 may be a generator, a flywheel, a propeller, or other apparatus that may be driven by the rotating shaft 103.

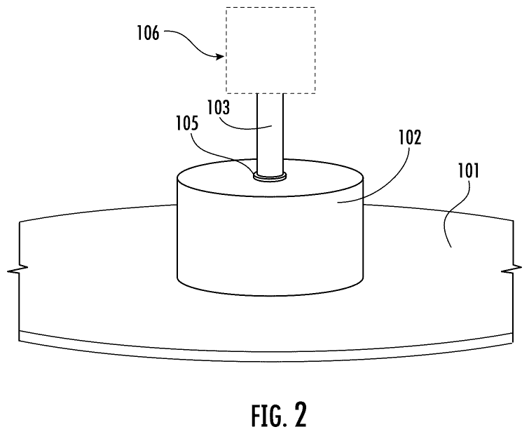

FIG. 2 depicts a perspective view of the leak containment system according to one example embodiment of the present disclosure. A segment of a containment vessel 101 is shown with a secondary leak containment and support housing 102 mounted to the outer surface of the containment vessel 101. A shaft 103 (e.g., drive shaft) is shown protruding from a distal surface of the secondary leak containment and support housing 102 through a second drive seal aperture 145 defined by the secondary leak containment and support housing 102. At such location of the protrusion, a secondary seal 105 is disposed at least partially within the second drive seal aperture 145 such that it is structured to provide gas-tight sealing (e.g., a second gas-tight seal) between the shaft 103 and the secondary leak containment and support housing 102 (e.g., around the shaft 103), sealing the second drive seal aperture 145 of the secondary leak containment and support housing 102 to the shaft 103.

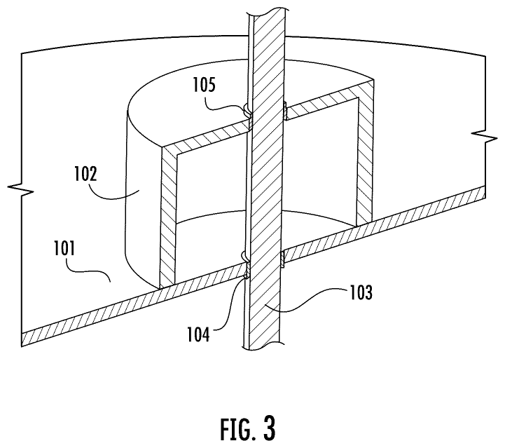

FIG. 3 illustrates a section view of the leak containment system of FIG. 2, depicting an internal view of the leak containment system. A segment of a containment vessel 101 is shown with a secondary leak containment and support housing 102 mounted to (or formed as part of) the outer surface of the containment vessel 101. A shaft 103 is shown extending through a first drive shaft seal aperture 140 defined by the containment vessel 101 and through a second drive shaft seal aperture 145 defined by the secondary leak containment and support housing 102, such that the shaft 103 extends from internally of the containment vessel 101 to the outer surface of the secondary leak containment and support housing 102. A primary seal 104 is disposed at least partially within the gap of the first drive shaft seal aperture 140 between the shaft 103 and the containment vessel 101, such that the primary seal 104 is structured to provide gas-tight sealing (e.g., a first gas-tight seal) between the shaft 103 and the containment vessel 101. A secondary seal 105 is disposed at least partially within the gap of the second drive shaft seal aperture 145 between the shaft 103 and the secondary leak containment and support housing 102, such that the secondary seal 105 is structured to provide gas-tight sealing (a second gas-tight seal) between the shaft 103 and the secondary leak containment and support housing 102.

In some embodiments, a nuclear power generation apparatus has a containment vessel 101 to contain the reactor core with fissile material, internals, and the working fluid or operating gas. That is, a containment vessel 101 houses, holds, or otherwise contains a working fluid or operating gas (e.g., used as the reactor coolant, and in some cases, a gas propellant for the energy conversion, of the nuclear power generation apparatus). Such a fluid may or may not be inert. For example, in some embodiments, the operating gas is any suitable gas, such as air, argon, hydrogen, helium, carbon dioxide, xenon, neon, nitrogen, or other suitable gas, including combinations of one or more suitable gases. For instance, in some embodiments, the operating gas includes atmospheric gas in the environment on or surrounding Earth, Mars, or other planets.

An example direct-cycle nuclear power generation apparatus, as depicted in FIG. 1A, may comprise a containment vessel 101 housing a gas propellant chamber 120, which includes an inlet assembly (e.g., compressor) 121, a nuclear fuel chamber (e.g., nuclear fuel elements) 122, and an exhaust assembly (e.g., nozzle, turbine assembly) 123, the containment vessel 101 defining a circulation path 124 for the operating gas to flow. A variety of configurations of the nuclear power generation apparatus and containment vessel 101 are available and may be used without deviating from the intent of the present disclosure.

The containment vessel 101 may include a shaft 103 extending through the first drive shaft seal aperture 140 defined in a wall (e.g., secondary leak containment and support housing engagement wall 130 as depicted in FIGS. 4A and 5A) in the containment vessel 101, such that shaft extends from an inner surface or cavity of the containment vessel 101 to an outer surface or externally of the containment vessel 101. The location of the first drive shaft seal aperture 140 (where the shaft 103 passes through the containment vessel 101) may be sealed by a primary seal 104 disposed at least partially within the first drive shaft seal aperture 140, providing gas-tight sealing (first gas-tight seal) between the shaft 103 and the containment vessel 101 in order to prevent or reduce gas from passing through this aperture 140.

In some embodiments, the shaft 103 acts as a drive shaft to transfer a rotative force (e.g., of the nuclear power generation apparatus) to a payload 106. For example, in certain embodiments, the payload 106 of the drive shaft 103 is a generator. In other embodiments, the payload 106 may be a flywheel, a propeller, or other apparatus that may be driven by the rotating shaft 103.

According to some embodiments, the containment vessel 101 may include a threaded collar disposed about the opening (proximate the first drive shaft seal aperture 140) through which the shaft 103 passes out of the containment vessel 101. Additionally or alternatively, the secondary leak containment and support housing 102 may include a mating thread such that the housing 102 is configured to be threaded onto the collar and tightened to create an air-tight seal. The mating surfaces of the secondary leak containment and support housing 102 and the containment vessel 101 may be designed in such a way to provide an improved posture for sealing, such as complementary surfaces.

In some embodiments, the containment vessel 101 may utilize any combination of sensors for monitoring radiation and/or determining gas composition, pressure, temperature, and/or moisture so that the gas in the containment vessel 101 and/or the secondary leak containment and support housing 102 may be monitored and/or maintained.

The secondary leak containment and support housing 102 of an example embodiment is sealed to the outer surface of the containment vessel 101. In some embodiments, the mechanism of sealing may be at least partially dependent upon the materials used for the secondary leak containment and support housing 102 and the containment vessel 101. According to one embodiment in which the secondary leak containment and support housing 102 and the containment vessel 101 are of compatible materials or of the same material, such as a metal, the secondary leak containment and support housing 102 may be welded to the containment vessel. In an embodiment in which the components are composites, such as fiberglass, carbon fiber, etc., the containment vessel 101 and secondary leak containment and support housing 102 may be secured together using additional layers of composite, an epoxy, or a glue, for example. In some embodiments, the secondary leak containment and support housing 102 is formed of a nuclear qualified material.

In some embodiments, the secondary leak containment and support housing 102 may be formed together as an integral unit with the containment vessel 101. Optionally, in some embodiments, the secondary leak containment and support housing 102 may be embedded, wholly or partially, in the containment vessel 101. FIGS. 5A-5C depict an example of a secondary leak containment and support housing 102 partially embedded in a containment vessel 101. As depicted in FIGS. 5A and 5B, in some embodiments, a containment vessel 101 is structured to define a first drive shaft seal aperture 140. For example, the containment vessel 101 may define the first drive seal aperture 140 in a wall of the containment vessel 101 that engages with or is positioned adjacent to the secondary leak containment and support housing 102 (e.g., the secondary leak containment and support housing 102 may be partially or wholly embedded in a secondary leak containment and support housing engagement wall 130 of the containment vessel 101). In some embodiments, the secondary leak containment and support housing engagement wall 130 of the containment vessel 101 may comprise a reinforcement plate 150 structured to provide additional structural support to and/or stabilize the secondary leak containment and support housing 102. For example, the reinforcement plate 150 may be attached to or otherwise formed as a part of the secondary leak containment and support housing engagement wall 130 of the containment vessel 101.

In some embodiments, as depicted in FIG. 5A, the secondary leak containment and support housing 102 comprises a distal wall 125 and a containment vessel engagement wall 126. For example, the depicted containment vessel engagement wall 126 engages with or is otherwise positioned proximate the secondary leak containment and support housing engagement wall 130 of the containment vessel 101, at least as compared to the relative positioning of the distal wall 125. As depicted in FIGS. 4A and 5A, the secondary leak containment and support housing engagement wall 130 includes a reinforcement plate 150 such that the reinforcement plate 150 engages with the containment vessel engagement wall 126 of the secondary leak containment and support housing 102. In alternative embodiments (not shown), the secondary leak containment and support housing engagement wall 130 may not include the depicted reinforcement plate 150.

The distal wall 125 of the secondary leak containment and support housing 102 is structured to define a second drive shaft seal aperture 145 as depicted in FIGS. 5A and 5C (and as similarly depicted in FIGS. 4A and 4C). In some embodiments, the containment vessel engagement wall 126 is structured to define a third drive shaft seal aperture 155. In the embodiments depicted in FIGS. 5A and 5B, the first drive shaft seal aperture 140 of the containment vessel 101 and the third drive shaft seal aperture 155 of the secondary leak containment and support housing 102 are concentrically aligned relative to imaginary axis A, which represents the axis of rotation for shaft 103 (e.g., a drive shaft) as discussed in greater detail below.

In the depicted embodiment, first drive shaft seal aperture 140 and the third drive shaft seal aperture 155 are positioned such that the first drive shaft seal aperture 140 surrounds (defines a larger diameter than) the third drive shaft seal aperture 155. This positioning structurally enables, in some embodiments, an extended portion 127 of the containment vessel engagement wall 126 to extend within the containment vessel 101 (i.e., to extend at least partially beyond the secondary leak containment and support housing engagement wall 130).

In the depicted embodiment, the extended portion 127 defines an outer surface 136 that is sized to engage and seal an inner surface 129 of the first drive shaft seal aperture 140. The depicted extended portion 127 of the containment vessel engagement wall 126 further defines an inner surface 135 defining the third drive shaft seal aperture 155.

As depicted in FIG. 5A, a shaft 103 extends through each of the first drive shaft seal aperture 140 of the containment vessel 101, the second drive shaft seal aperture 145 of the secondary leak containment and support housing 102, and the third drive shaft seal aperture 155 of the secondary leak containment and support housing 102. That is, the first drive shaft seal aperture 140 and the third drive shaft seal aperture 155 share a common axis (e.g., the shaft 103). The shaft 103 may be a drive shaft that is configured to rotate relative to the containment vessel 101 and the secondary leak containment and support housing 102.

In one embodiment, the secondary leak containment and support housing 102 and the containment vessel 101 are of compatible materials or of the same material, such as a metal. In certain embodiments, the secondary leak containment and support housing 102 is welded to or otherwise sealed to the containment vessel 101. For example, in embodiments such as the embodiment depicted in FIG. 5A-5C, the containment vessel engagement wall 126 is welded to or otherwise sealed to the reinforcement plate 150 (and/or the top surface of the engagement wall 130) and the outer surface 136 of the extended portion 127 is welded to or otherwise sealed to the engagement wall 130. In other embodiments, such as when the secondary leak containment and support housing 102 and the containment vessel 101 are formed of composites, such as fiberglass, carbon fiber, etc., the containment vessel engagement wall 126 is secured or otherwise sealed (e.g., using additional layers of composite, an epoxy, or a glue) to the reinforcement plate 150 (and/or the top surface of the engagement wall 130) and the outer surface 136 of the extended portion 127 is secured or otherwise sealed (e.g., using additional layers of composite, an epoxy, or a glue) to the engagement wall 130. In some embodiments, the secondary leak containment and support housing 102 is formed of a nuclear-qualified material.

A secondary leak containment and support housing 102 may include a flange disposed about the housing 102 and the flange secured to the containment vessel 101. Such attachment may be made with fasteners and/or gaskets. In some embodiments, the area of the containment vessel 101 surrounding, adjacent to, or in proximity of where the shaft 103 passes through the containment vessel 101 may itself be configured in a manner that facilitates how the secondary leak containment and support housing 102 may be mounted. For example, the architecture of the area around where the shaft 103 extends through the containment vessel 101 may facilitate how the secondary leak containment and support housing 102 may be mounted as depicted in FIGS. 4A and 5A.

In some embodiments, the attachment between the containment vessel 101 and the secondary leak containment and support housing 102 needs to be air-tight. In some embodiments, a sealing material may be disposed at the interfacing of the secondary leak containment and support housing 102 and the surface(s) of the containment vessel 101. Additionally or alternatively, the outer surface of the containment vessel 101 may be structured with a lip-or ledge-type feature to accommodate the intersection of the secondary leak containment and support housing 102 and the outer surface of the containment vessel 101.

In some embodiments, the secondary leak containment and support housing 102 may incorporate one or more of thermal shielding or radiation shielding. For example, in some embodiments, such shielding may be disposed on the outer surface of the containment vessel 101, forming one wall of the secondary leak containment and support housing 102. In other embodiments, shielding may line one or more additional inner surfaces of the secondary leak containment and support housing 102.

In some embodiments, the secondary leak containment and support housing 102 is filled with an inert fluid which has low reactivity, such as helium. In other embodiments, the secondary leak containment and support housing 102 is filled with a non-inert fluid (e.g., non-low-reactivity gas), such as nitrogen or carbon dioxide. In some embodiments, the fluid inside the secondary leak containment and support housing 102 has the same or similar composition to the fluid inside the containment vessel 101. In other embodiments, the fluid in the secondary leak containment and support housing 102 is different than the fluid in the containment vessel 101. The fluid in the secondary leak containment and support housing 102 may have properties desirable for leak prevention and detection. In some embodiments, the fluid in the secondary leak containment and support housing 102 may be a mixture of two or more fluids including but not limited to any combination of air, argon, hydrogen, helium, carbon dioxide, xenon, neon, nitrogen, or other suitable gas.

In some embodiments, the fluid within the secondary leak containment and support housing 102 may be held at a pressure higher than that of the fluid within the containment vessel 101. In this way, the secondary leak containment and support housing 102 would sooner leak into the containment vessel 101 than any fluid in the containment vessel 101 would leak to the secondary leak containment and support housing 102. In such an embodiment, the fluid within the secondary leak containment and support housing 102 may also be at a higher pressure than the atmosphere around the containment vessel 101. Hence, use of an inert fluid in the secondary leak containment and support housing 102 may be desirable in some embodiments. In other embodiments, the housing 102 is at a pressure equal to or lower than that of the containment vessel 101. The pressure in the housing 102 may be equal to or less than atmospheric pressure.

In some embodiments, the secondary leak containment and support housing 102 may utilize any combination of sensors for monitoring radiation and/or determining gas composition, pressure, temperature, and/or moisture levels inside the housing 102 for maintaining the desired environment inside the housing 102. Such sensors may also provide an indication of a potential leak. For example, if the fluid within the secondary leak containment and support housing 102 is held at a higher pressure than the containment vessel 101, a pressure sensor monitoring pressure in the secondary leak containment and support housing 102 may identify a diffusion through or leak from the containment vessel 101 or a leak from the secondary leak containment and support housing 102 in response to the pressure reading decreasing. In the event that the decreased pressure reading is due to a diffusion through or a leak from the containment vessel 101, the pressure reading in the secondary leak containment and support housing 102 will aid in confirming this is the case and provide other useful data for analyzing the circumstances of the diffusion or leak. In an embodiment in which the fluid within the secondary leak containment and support housing 102 is held at a lower pressure than fluid within the containment vessel 101, a rise in pressure in the secondary leak containment and support housing 102 may indicate a leak from the containment vessel 101 through the primary seal into the secondary leak containment and support housing 102.

The fluid contained inside the containment vessel 101 of an example embodiment may be prevented from escaping at the first drive shaft seal aperture 140 (and/or the third drive shaft seal aperture 155 such as in FIGS. 5A and 5B) through which the shaft 103 extends by at least a primary seal 104. Similarly, the fluid contained in the secondary leak containment and support housing 102 may be prevented from escaping at the second drive shaft seal aperture 145 through which the shaft 103 extends by at least a secondary seal 105.

The types of seals used for the primary and secondary seals 104, 105 may include metal seals, labyrinth seal systems, cylindrical tesla valves, or other seals familiar to one skilled in the art to provide gas-tight sealing between the shaft 103 and the corresponding component of the leak containment system. The primary and secondary seals 104, 105 may be similar or different. In some embodiments, the primary seal 104 may allow for unidirectional flow from the secondary leak containment and support housing 102 into the containment vessel 101.

The determination of the seals 104, 105 may depend on any one or more of several factors. In the case for the primary seal 104, for example, the temperature and composition of the fluid within the containment vessel 101, the pressure in the containment vessel 101, the pressure and composition of the gas in the containment vessel 101, the pressure differential between the gas in the containment vessel 101 and the gas in the housing 102, the thickness and configuration of the containment vessel 101 and adjoining bearings and other drive shaft support at the point of the penetration of the shaft 103. In the case of the secondary seal 105, among other factors, the temperature, pressure and composition of the gas in the secondary leak containment and support housing 102, the thickness and configuration of the secondary leak containment and support housing 102 and adjoining bearings, other support at the point of the penetration of the shaft 103, and the expected ambient conditions.

In some embodiments, a one-way valve (e.g., a check valve) may be utilized at the primary seal 104 to allow fluid to flow from the housing 102 into the containment vessel 101 (e.g., to replenish gas that has leaked from the containment vessel 101). The valve may be of the type used in the aerospace industry or those familiar to someone skilled in the art. In some embodiments, the valve may incorporate a removeable cap at the entry to the valve. Additionally or alternatively, the secondary leak containment and support housing 102 may incorporate a valve. Such a valve in the housing 102 may allow fluid to be added or released to the housing 102. The housing valve may be used to alter the fluid or alter the mixture of the fluid. In some instances, the housing valve may be a one-way valve for the use of injecting fluid into the secondary leak containment and support housing 102.

In some embodiments, the secondary leak containment and support housing 102 may be used for the purpose of filling the containment vessel 101 with a desired fluid or used in connection with a purification system (not pictured) for purifying the fluid in the containment vessel 101. This may be accomplished by utilizing a higher pressure in the housing 102 in combination with either a unidirectional primary seal 104 or other techniques familiar to one of ordinary skill in the art to diffuse fluid into the containment vessel 101. Such technique enables the system associated with the containment vessel 101 (e.g., nuclear power generation apparatus) to not be shut down to replenish the fluid inside the containment vessel 101.

In some embodiments, the construction of the secondary leak containment and support housing 102 may be made in the shape of a cylinder as depicted in FIGS. 1A-3. Although depicted as having a generally cylindrical body, as would be evident to one of ordinary skill in the art in light of the present disclosure, the present disclosure contemplates that the secondary leak containment and support housing 102 may be formed of any shape designed to meet structural objectives to the embodiments of the present disclosure. In some embodiments, the secondary leak containment and support housing 102 may utilize internal supports to meet structural objectives. FIG. 5A depicts a partially embedded secondary leak containment and support housing 102 as an example of an assembly that may be used to incorporate structural support for the rotating drive shaft 103. Other structural methods familiar to one skilled in the art may be used to enhance the structural integrity.

In many embodiments, the secondary leak containment and support housing 102 may be made from a similar material as the containment vessel 101. In other embodiments, the secondary leak containment and support housing 102 is made from a material which is different from the containment vessel 101. In some embodiments, the materials for the secondary leak containment and support housing 102 may be steel, Inconel® Alloy 1718, or another qualified alloy.

The secondary leak containment and support housing 102 may provide lateral support to the shaft 103 at a distance from the primary seal 104. For example, the secondary seal 105 of the secondary leak containment and support housing 102 may provide additional support against drive shaft vibration. In other words, such additional support may be beneficial to prevent a shaft 103 (e.g., a drive shaft) from vibrating, thereby reducing premature wear on the seals and components and preventing or otherwise reducing leaks. Additionally or alternatively, support for the shaft 103 may be provided through one or more bearings disposed at such seals. For example, in some embodiments, magnetic bearings or other high-performance bearings (such as oil bearings with gas seals) are utilized to provide support for the shaft 103 and/or minimize friction.

The following exemplary embodiments are provided, the numbering of which is not to be construed as designating levels of importance or relevance.

Embodiment 1 provides a leak containment system comprising a containment vessel structured to define a first drive shaft seal aperture, a secondary leak containment and support housing secured to the containment vessel wherein the secondary leak containment and support housing is structured to define a second drive shaft seal aperture, a drive shaft extending through the first drive shaft seal aperture of the containment vessel and through the second drive shaft seal aperture of the secondary leak containment and support housing, wherein the drive shaft is configured to rotate relative to the containment vessel and the secondary leak containment and support housing, a primary seal disposed at least partially within the first drive shaft seal aperture that is structured to provide gas-tight sealing between the drive shaft and the containment vessel; and a secondary seal disposed at least partially within the second drive shaft seal aperture that is structured to provide gas-tight sealing between the drive shaft and the secondary leak containment and support housing.

Embodiment 2 provides the leak containment system of Embodiment 1, further comprising a gas disposed within the secondary leak containment and support housing, wherein the gas within the secondary leak containment and support housing is held at a first pressure higher than a second pressure of a fluid within the containment vessel.

Embodiment 3 provides the leak containment system of any one of Embodiments 1-2, wherein the first pressure is greater than an atmospheric pressure surrounding the containment vessel.

Embodiment 4 provides the leak containment system of any one of Embodiments 1-3, the leak containment system further comprising one or more pressure sensors configured to detect a pressure of the gas within the secondary leak containment and support housing.

Embodiment 5 provides the leak containment system of any one of Embodiments 1-4, the leak containment system further comprising a valve disposed in the secondary leak containment and support housing, wherein the valve is configured to enable the gas within the secondary leak containment and support housing to be pressurized.

Embodiment 6 provides the leak containment system of any one of Embodiments 1-5, the leak containment system further comprising a valve disposed in the secondary leak containment and support housing, wherein the valve is configured to allow fluids to be added or released from the secondary leak containment and support housing.

Embodiment 7 provides the leak containment system of any one of Embodiments 1-6, the leak containment system further comprising one or more sensors configured to monitor radiation, determine gas composition, detect moisture levels, or detect temperature in the secondary leak containment and support housing.

Embodiment 8 provides the leak containment system of any one of Embodiments 1-7, wherein one or more bearings are disposed in association with the secondary seal.

Embodiment 9 provides the leak containment system of any one of Embodiments 1-8, wherein the gas within the secondary leak containment and support housing is inert or a low-reactivity gas.

Embodiment 10 provides the leak containment system of any one of Embodiments 1-9, wherein the gas within the secondary leak containment and support housing is non-inert or a non-low-reactivity gas.

Embodiment 11 provides the leak containment system of any one of Embodiments 1-10, wherein the containment vessel houses a reactor core with fissile material for a nuclear power generation apparatus.

Embodiment 12 provides a leak containment system comprising a containment vessel structured to define a first drive shaft seal aperture, a secondary leak containment and support housing wholly or partially embedded in the containment vessel, wherein the secondary leak containment and support housing comprises a distal wall and a containment vessel engagement wall, wherein the distal wall is structured to define a second drive shaft seal aperture and the containment vessel engagement wall is structured to define a third drive shaft seal aperture, and wherein the first drive shaft seal aperture of the containment vessel and the third drive shaft seal aperture of the secondary leak containment and support housing are concentrically aligned, a drive shaft extending through the first drive shaft seal aperture of the containment vessel and the second drive shaft seal aperture and the third drive shaft seal aperture of the secondary leak containment and support housing, wherein the drive shaft is configured to rotate relative to the containment vessel and the secondary leak containment and support housing, a primary seal disposed at least partially within the third drive shaft seal aperture that is structured to provide gas-tight sealing between the drive shaft and the secondary leak containment and support housing proximate the containment vessel; and a secondary seal disposed at least partially within the second drive shaft seal aperture that is structured to provide gas-tight sealing between the drive shaft and the secondary leak containment and support housing at the wall of the secondary leak containment and support housing opposite the containment vessel.

Embodiment 13 provides the leak containment system of Embodiment 12, wherein the secondary leak containment and support housing and the containment vessel are of compatible materials or of the same material.

Embodiment 14 provides the leak containment system of any one of Embodiments 12-13, wherein the secondary leak containment and support housing is formed of a nuclear-qualified material.

Embodiment 15 provides the leak containment system of any one of Embodiments 12-14, further comprising a gas within the secondary leak containment and support housing, wherein the gas within the secondary leak containment and support housing is held at a first pressure higher than a second pressure of a fluid within the containment vessel.

Embodiment 16 provides the leak containment system of any one of Embodiments 12-15, wherein the first pressure is greater than an atmospheric pressure surrounding the containment vessel.

Embodiment 17 provides the leak containment system of any one of Embodiments 12-16, the leak containment system further comprising one or more pressure sensors configured to detect a pressure of the gas within the secondary leak containment and support housing.

Embodiment 18 provides the leak containment system of any one of Embodiments 12-17, the leak containment system further comprising a valve disposed in the secondary leak containment and support housing, wherein the valve is configured to enable the gas within the secondary leak containment and support housing to be pressurized.

Embodiment 19 provides the leak containment system of any one of Embodiments 12-18, the leak containment system further comprising a valve disposed in the secondary leak containment and support housing, wherein the valve is configured to allow fluids to be added or released from the secondary leak containment and support housing.

Embodiment 20 provides the leak containment system of any one of Embodiments 12-19, wherein an extended portion of the containment vessel engagement wall is structured to extend within the containment vessel, the extended portion defines an outer surface that is sized to engage and seal an inner surface of the first drive shaft seal aperture, and the extended portion further defines an inner surface defining the third drive shaft seal aperture.

### Conclusion

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A leak containment system comprising:
a containment vessel structured to define a first drive shaft seal aperture;
a secondary leak containment and support housing secured to the containment vessel, wherein the secondary leak containment and support housing is structured to define a second drive shaft seal aperture;
a drive shaft extending through the first drive shaft seal aperture of the containment vessel and through the second drive shaft seal aperture of the secondary leak containment and support housing, wherein the drive shaft is configured to rotate relative to the containment vessel and the secondary leak containment and support housing;
a primary seal disposed at least partially within the first drive shaft seal aperture that is structured to provide gas-tight sealing between the drive shaft and the containment vessel; and
a secondary seal disposed at least partially within the second drive shaft seal aperture that is structured to provide gas-tight sealing between the drive shaft and the secondary leak containment and support housing.

2. The leak containment system of claim 1, further comprising a gas disposed within the secondary leak containment and support housing, wherein the gas within the secondary leak containment and support housing is held at a first pressure higher than a second pressure of a fluid within the containment vessel.

3. The leak containment system of claim 2, wherein the first pressure is greater than an atmospheric pressure surrounding the containment vessel.

4. The leak containment system of claim 3, further comprising one or more pressure sensors configured to detect a pressure of the gas within the secondary leak containment and support housing.

5. The leak containment system of claim 4, further comprising a valve disposed in the secondary leak containment and support housing, wherein the valve is configured to enable the gas within the secondary leak containment and support housing to be pressurized.

6. The leak containment system of claim 4, further comprising a valve disposed in the secondary leak containment and support housing, wherein the valve is configured to allow fluids to be added or released from the secondary leak containment and support housing.

7. The leak containment system of claim 1, further comprising one or more sensors configured to monitor radiation, determine gas composition, detect moisture levels, or detect temperature in the secondary leak containment and support housing.

8. The leak containment system of claim 1, wherein one or more bearings are disposed in association with the secondary seal.

9. The leak containment system of claim 2, wherein the gas within the secondary leak containment and support housing is inert or a low-reactivity gas.

10. The leak containment system of claim 2, wherein the gas within the secondary leak containment and support housing is non-inert or a non-low-reactivity gas.

11. The leak containment system of claim 1, wherein the containment vessel houses a reactor core with fissile material for a nuclear power generation apparatus.

12. A leak containment system comprising:
a containment vessel structured to define a first drive shaft seal aperture;
a secondary leak containment and support housing wholly or partially embedded in the containment vessel, wherein the secondary leak containment and support housing comprises a distal wall and a containment vessel engagement wall, wherein the distal wall is structured to define a second drive shaft seal aperture and the containment vessel engagement wall is structured to define a third drive shaft seal aperture, and wherein the first drive shaft seal aperture of the containment vessel and the third drive shaft seal aperture of the secondary leak containment and support housing are concentrically aligned;
a drive shaft extending through the first drive shaft seal aperture of the containment vessel and the second drive shaft seal aperture and the third drive shaft seal aperture of the secondary leak containment and support housing, wherein the drive shaft is configured to rotate relative to the containment vessel and the secondary leak containment and support housing;
a primary seal disposed at least partially within the third drive shaft seal aperture that is structured to provide gas-tight sealing between the drive shaft and the secondary leak containment and support housing proximate the containment vessel; and
a secondary seal disposed at least partially within the second drive shaft seal aperture that is structured to provide gas-tight sealing between the drive shaft and the secondary leak containment and support housing at the distal wall of the secondary leak containment and support housing opposite the containment vessel.

13. The leak containment system of claim 12, wherein the secondary leak containment and support housing and the containment vessel are of compatible materials or of the same material.

14. The leak containment system of claim 12, wherein the secondary leak containment and support housing is formed of a nuclear-qualified material.

15. The leak containment system of claim 12, further comprising a gas disposed within the secondary leak containment and support housing, wherein the gas within the secondary leak containment and support housing is held at a first pressure higher than a second pressure of a fluid within the containment vessel.

16. The leak containment system of claim 15, wherein the first pressure is greater than an atmospheric pressure surrounding the containment vessel.

17. The leak containment system of claim 16, further comprising one or more pressure sensors configured to detect a pressure of the gas within the secondary leak containment and support housing.

18. The leak containment system of claim 17, further comprising a valve disposed in the secondary leak containment and support housing, wherein the valve is configured to enable the gas within the secondary leak containment and support housing to be pressurized.

19. The leak containment system of claim 17, further comprising a valve disposed in the secondary leak containment and support housing, wherein the valve is configured to allow fluids to be added or released from the secondary leak containment and support housing.

20. The leak containment system of claim 12, wherein:
an extended portion of the containment vessel engagement wall is structured to extend within the containment vessel,
the extended portion defines an outer surface that is sized to engage and seal an inner surface of the first drive shaft seal aperture, and
the extended portion further defines an inner surface defining the third drive shaft seal aperture.
